(19) United States
(12) Patent Application Publication
(10) Pub. No.: US 2018/0026948 A1
(43) Pub. Date: Jan. 25, 2018

(54) SYSTEM AND METHOD FOR ENCRYPTING AND DECRYPTING DATA

(71) Applicant: myTALKEY s.r.o., Ostrava (CZ)

(72) Inventors: Vladimir Lazecky, Hradec nad Moravici (CZ); Rudolf Müller, Brno Zabrdovice (CZ); Jan Müller, Ceska (CZ)

(21) Appl. No.: 15/217,800

(22) Filed: Jul. 22, 2016

(51) Int. Cl. H04L 29/06; H04L 9/14

(52) U.S. Cl. CPC H04L 63/0428; H04L 9/14

(57) ABSTRACT

A system and method for encrypting and decrypting data for communication via a communication device, in which at least certain aspects of the encryption and decryption functions are performed on a chip and using physical signal conductors rather than in software. The chip includes a chip controller for managing the other components, an encryption/decryption module for performing the encryption and decryption functions, a memory element for containing the encryption and decryption keys, and an I/O control module for controlling input and output operations. These components are connected by the physical signal conductors which facilitate communication therebetween under the control of a protocol provided by the chip controller. The chip may also include an RF spectrum analyser for analysing signals to determine whether electronic eavesdropping is occurring, in which case the user is warned if eavesdropping is detected.

### FIELD

The present invention relates to systems and methods for encrypting and decrypting data, and more particularly, to a system and method in which at least certain aspects of encrypting and decrypting data are performed on a chip and using physical signal conductors rather than in software.

### BACKGROUND

Encryption and decryption of the content of a transmission between communication devices is often used to ensure confidentiality. The development of such technologies as mobile phones and the Internet of Things (IoT) makes such secure communication highly desirable.

Existing encryption/decryption technology generally uses software solutions. At the level of “smart” mobile phones and other IoT devices, software is the most widely used solution because it does not require physical interventions or modifications of technical equipment. Thus, security is provided by software which is a layer above the operating system. The determining factors for these solutions are the reliability of the software and the resilience of the operating system against attacks. Both factors are very difficult to achieve. For these reasons, achieving secure communication using software is very difficult or impossible, and there are numerous commercial and non-commercial products and procedures for breaking encrypted communication at the software level.

Further, the storage locations of encryption keys are identifiable, and therefore it is possible through a variety of sophisticated procedures to obtain the keys. Moreover, the encryption keys appear in unencrypted form even outside of their storage locations, such as on internal buses or in memory elements, so it is possible to obtain the keys by other procedures. Additionally, current solutions involve the radiation of electromagnetic waves into space, which has its origin in the activity of each electronic device. By analysing this spectrum, it is at least in principle possible to obtain the encryption keys. Additionally, a number of relevant parameters are easily available, such as fluctuations in the offtake of electrical energy. By analysing these spectra, it is possible to obtain the encryption keys. Additionally, there is a lack of integrated detection of spatial wiretaps. Left unchecked, this very serious security problem may totally compromise the security of a transmission from a communication device. More specifically, in the case of voice communication and the presence of spatial eavesdropping, the security of the encrypted transfer may be zero.

This background discussion is intended to provide information related to the present invention which is not necessarily prior art.

### SUMMARY

Embodiments of the present invention solve the above-described and other problems and limitations by providing a system and method for encrypting and decrypting data for communication via a communication device, in which at least certain aspects of the encryption and decryption functions are performed on a chip and using physical signal conductors rather than in software.

In a first embodiment, a system for encrypting and decrypting data for communication via a communication device may broadly comprise a chip including a memory element, an encryption/decryption module, an input/output control module, and at least one chip controller. The memory element may store an encryption key and a decryption key. The encryption/decryption module may encrypt transmit data using the encryption key stored in the memory element and decrypt receive data using the decryption key stored in the memory element. The input/output control module may control input operations to the chip from one or more input devices and output operations from the chip to one or more output devices. The chip controller may manage operations of and communication between the memory element, the encryption/decryption module, and the input/output control module. The memory element, the encryption/decryption module, the input/output control module, and the chip controller may be physically connected by and communicate with each other using a plurality of physical signal conductors.

In various implementations, the system may further include any one or more of the following features. The encryption/decryption module may send the transmit data to a modem for transmission, and receive the receive data from the modem. The chip controller may provide a communication protocol for managing communication via the plurality of physical signal conductors. The chip controller may communicate with a network server via a data network to initially access the encryption key and the decryption key which are then stored in the memory element. The system may further include a security hardware element preventing unauthorized access to the encryption key and the decryption key stored in the memory element. The system may further include a radio-frequency spectrum analyzer detecting electronic eavesdropping, and communicating detection of electronic eavesdropping on a display of the communication device.

In a second embodiment, a system for encrypting and decrypting data for communication via a mobile communication device may broadly comprise a chip incorporated into the mobile communication device and including a plurality of physical signal conductors, a memory element, an encryption/decryption module, an input/output control module, and at least one chip controller. The physical signal conductors may facilitate communication of electronic signals. The memory element may store an encryption key and a decryption key. The encryption/decryption module may be in communication via the plurality of physical signal conductors with the memory element and a modem component of the mobile communication device, and may encrypt transmit data for transmission via the modem component using the encryption key stored in the memory element and decrypt receive data received via the modem component using the encryption key stored in the memory element. The input/output control module may control input operations to the chip from one or more input devices and output operations from the chip to one or more output devices. The chip controller may be in communication via the plurality of physical signal conductors with and manage operations of the memory element, the encryption/decryption module, and the input/output control module, and may provide a communication protocol for managing communication via the plurality of physical signal conductors.

In various implementations, the system may further include any one or more of the following features. The chip controller may communicate with a network server via a data network to initially access the encryption key and the decryption key which are then stored in the memory element. The system may further include a security hardware element preventing unauthorized access to the encryption key and the decryption key stored in the memory element. The system may further include a radio-frequency spectrum analyzer detecting electronic eavesdropping, and communicating detection of electronic eavesdropping on a display of the mobile communication device.

This summary is not intended to identify essential features of the present invention, and is not intended to be used to limit the scope of the claims. These and other aspects of the present invention are described below in greater detail.

### DRAWINGS

Embodiments of the present invention are described in detail below with reference to the attached drawing figures, wherein:

FIG. 1 is a block diagram of an embodiment of a system for encrypting and decrypting data;

FIG. 2 is a block diagram showing certain components of the system of FIG. 1 or a variant implementation thereof;

FIG. 3 is a block diagram showing certain components of the system of FIG. 1 or a variant implementation thereof in association with a communication device;

FIG. 4 is a block diagram showing certain components of the system of FIG. 1 or a variant implementation thereof and having its own communication capability; and

FIG. 5 is a block diagram showing two instances of the system of FIG. 1 or variant implementations thereof being used to facilitate confidential communication between participants, including the transmission of keys for encrypted communication.

The figures are not intended to limit the present invention to the specific embodiments they depict. The drawings are not necessarily to scale.

### LISTING OF REFERENCE NUMERALS

1 the encryption/decryption chip
2 the chip controller
3 the interface of the management of the encryption/decryption module
4 the encryption/decryption module
5 the interface for the management of the control module (supervisor) of the input/output devices
6 the control module (supervisor) of the input/output devices
7 the management interface of the memory of keys
8 the memory of the encryption keys
9 the interface for the transmission of keys
10 the interface to the modem
11 the interface for the transmission of encrypted/decrypted information
12 the interface of the connected input/output devices
13 the analyser of the radio-frequency spectrum
14 the interface for detection of a radio signal
15 the interface of the analyser control
16 the safety hardware element for securing access to the keys
17 the input/output devices
18 the interface to an imaging device
19 the external modem of the communication device
20 the electronic display device
21 the external radio-frequency detector
22 the structure of a mobile communication device
23 the modem of the encryption/decryption part
24 the processor of the communication device
25 the interface to the modem of the encryption part
26 the interface to the structure of the mobile phone
27 the communication device
28 the server of the key management
29 the communication channel
30 the channel for transmission of keys

### DETAILED DESCRIPTION

The following detailed description of embodiments of the invention references the accompanying figures. The embodiments are intended to describe aspects of the invention in sufficient detail to enable those with ordinary skill in the art to practice the invention. Other embodiments may be utilized and changes may be made without departing from the scope of the claims. The following description is, therefore, not limiting. The scope of the present invention is defined only by the appended claims, along with the full scope of equivalents to which such claims are entitled.

In this description, references to “one embodiment”, “an embodiment”, or “embodiments” mean that the feature or features referred to are included in at least one embodiment of the invention. Separate references to “one embodiment”, “an embodiment”, or “embodiments” in this description do not necessarily refer to the same embodiment and are not mutually exclusive unless so stated. Specifically, a feature, structure, act, etc. described in one embodiment may also be included in other embodiments, but is not necessarily included. Thus, particular implementations of the present invention can include a variety of combinations and/or integrations of the embodiments described herein.

Broadly characterized, embodiments provide a system and method for more effectively and securely encrypting and decrypting data for communication via a communication device. More specifically, embodiments implement at least certain aspects of the encryption and decryption functions on a chip and using physical signal conductors rather than in software. Referring to FIG. 1, the chip 1 may include at least one chip controller 2; an encryption/decryption module 4 configured to perform encryption and decryption functions; a memory element 8 configured to contain encryption and decryption keys; and an input/output (I/O) control module 6 configured to control input and output operations. The components of the chip 1 may communicate with each other by various physical data interface connections. In particular, the chip 1 may include a plurality of these data interfaces in the form of a plurality of physical signal conductors physically connecting the various components and facilitating the communication of data and control commands therebetween. Communications via the data interfaces may be controlled by a protocol of the chip controller 2.

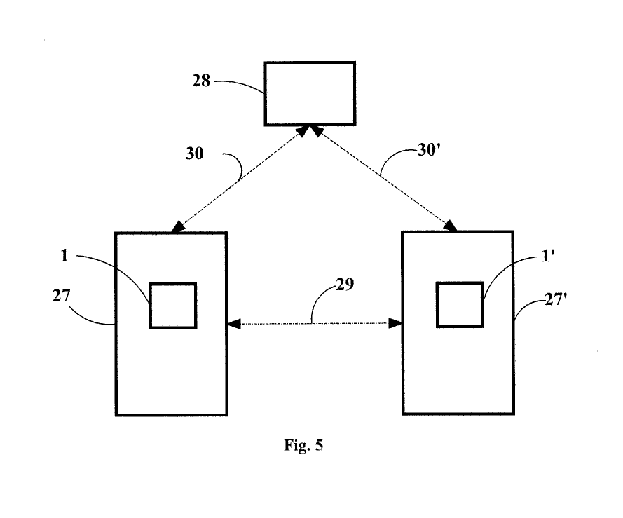

The chip controller 2 may be remotely connected (by, e.g., GPRS, WIFI, 3G) to a network server 28 (seen in FIG. 5) by a data network such as the Internet.

The memory element 8 which contains the encryption and decryption keys may include a security hardware element 16 for securing access to the keys, especially preventing unauthorized approaches from outside the system. The memory element 8 may take the form of substantially any suitable non-volatile electronic memory, such as Flash or EEPROM.

The chip 1 may further include a radio-frequency (RF) spectrum analyzer 13 connected to the chip controller 2, and including a digital signal processor configured to analyze electronic signals, such as for detecting electronic eavesdropping. The RF spectrum analyzer 13 may be further connected to a display 20 configured to visually communicate the results of the analysis of the electronic signals.

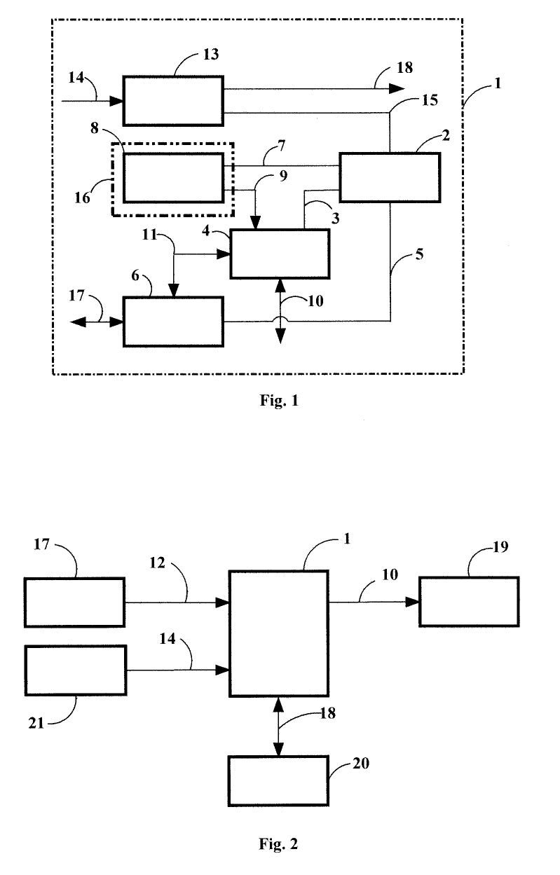

In more detail, referring to FIGS. 1-4, an exemplary embodiment of the system may be broadly characterized as follows. The chip 1 may comprise the at least one chip controller 2 connected by a data interface 3 to the encryption/decryption module 4, by a data interface 5 to the I/O control module 6, and by a data interface 7 to the memory element 8. The chip controller 2 may be further connected by a data interface 15 to the RF spectrum analyser 13. The RF spectrum analyser 13 may analyse electronic signals and communicate the results via a data interface 18 to the electronic display 20. The results may be displayed in the form of short message. The chip controller 2 may be further connected to the network server in order to access the encryption and decryption keys which are subsequently stored in the memory element 8.

The memory element 8 may be connected by a data interface 9 to the encryption/decryption module 4 so that the latter may, as needed, access the encryption and decryption keys stored in the former. The memory element 8 may be provided with the security hardware element 16 configured to further secure access to the keys.

The encryption/decryption module 4 may be connected by a data interface 25 to an internal modem 23 (seen in FIG. 4) which may be connected by a data interface 10 to a modem 19 of the communication device 27 (seen in FIG. 5), which may be a standard component of a mobile phone intended for wireless communication. The encryption/decryption module 4 may be connected by a data interface 11 to the I/O control module 6 for transmitting and receiving information to and from various input/output devices.

The I/O control module 6, which may be or at least include a microprocessor, may be connected by a data interface 12 to the various input/output devices 17, and may be configured to activate and deactivate the input/output devices 17. The input/output devices 17 may be substantially any suitable devices for transmitting or receiving information, such as microphones, speakers, modems, touch screens, keyboards, USB inputs, or GNSS.

Some or all of the data interface connections may be constructed on the chip 1 using substantially any suitable technology, such as ASIC, FPGA, or CPLD.

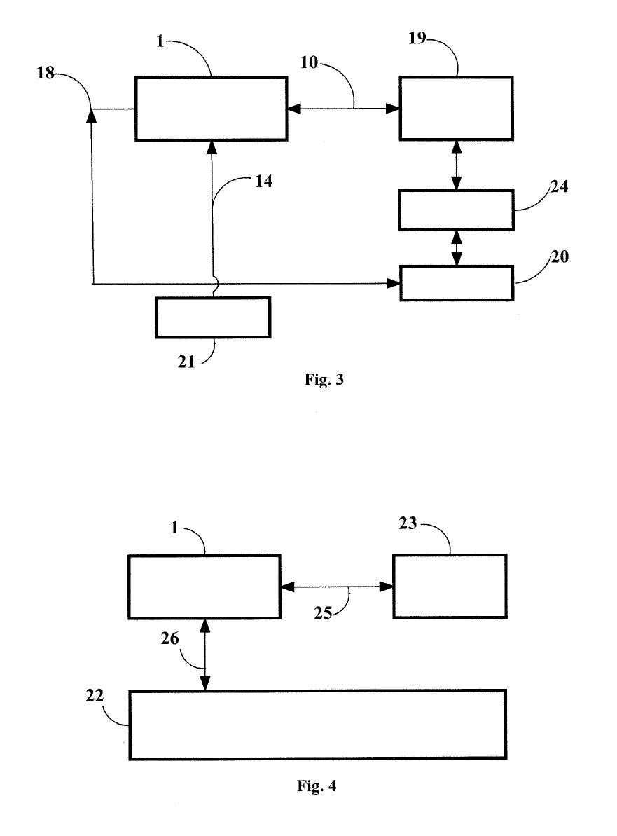

The chip 1 may be incorporated into substantially any suitable communication device 27, particularly a mobile communication device such as a mobile phone, laptop, tablet, or embedded IoT device. Further, each communication device 27,27′ involved in communicating information, whether transmitting or receiving or both, may include an instance of the chip 1. The communication device 27 may include various components 22 (broadly represented in FIG. 4), such as a processor 24 (seen in FIG. 3), and the chip 1 may be connected by a data interface 26 to one or more of these components 22.

For example, the chip 1 may be incorporated into a mobile phone. A user of the mobile phone may turn on the mobile phone and initiate a phone call by dialing a desired phone number. Such call initiation may include sending a label which identifies the call as being encrypted. Receipt of the label may result in activation of additional instances of the chip 1 incorporated in the communication devices of all recipients of the phone call.

More specifically, via data interface 14 the RF spectrum analyser 13 may receive a radio signal from an external radio-frequency detector 21. The RF spectrum analyser 13 may evaluate the received signal, and if an eavesdropping device is detected, the RF spectrum analyser 13 may notify the user of the mobile phone that the environment is not suitable for conducting confidential communication. This notification of the detection of the eavesdropping device may be sent through the data interface 18 to the electronic display device 20 (i.e., the display of the mobile phone) and visually communicated to the user as a short message. Being so notified, the user may end the call and leave the environment, continue the call without the use of encryption and encryption, or continue the call using encryption and decryption but with the knowledge that eavesdropping is occurring.

Whether eavesdropping is detected or not, if the user continues the call using encryption and decryption, the chip controller 2 may determine whether the encryption and decryption keys are stored in the memory element 8. If the keys are not present in the memory element 8, then the chip controller 2 may request via the data network that the remote server send the keys. The keys may be transmitted through the wireless data network and stored in the memory element 8.

Via the data interface 5 the chip controller 2 may instruct the I/O control module 6 to block the input/output devices 17. The input/output devices 17 may be all of the input and output mechanisms associated with the communication device 27 and by which it is possible to receive and transmit information, such as microphones, speakers, modems, touchscreens, keyboards, USB inputs, and/or GNSS. Additionally or alternatively, the input/output devices 17 may be disconnected from their power supply, or connected under the control of the chip 1.

In the case of a phone conversation, referring to FIG. 56, separate instances of the chip 1,1′ may be incorporated into separate instances of communication devices 27,27′ to facilitate confidential communication 29 between the devices 27,27′. In one implementation, each chip 1,1′ may access the server 28 via communication channels 30,30′ to download the encryption and decryption keys. At the transmitting communication device 27, the user's voice provides soundwaves which are converted by an electro-acoustic converter in the communication device 27 into electrical signals which can be encrypted. These signals are sent to the encryption/decryption module 4 for encryption. Via data interface 9 the encryption key may be sent from the memory element 8 to the encryption/decryption module 4, and used to encrypt the signals. Via data interface 10 the encrypted signals may be sent to the modem 19 of the communication device 27, which may transmit the encrypted signals to the receiving communication device 27′.

At the receiving communication device 27′ the encrypted signal may be received by the modem 19′ of the communication device 27′, via the data interface 10′ the encrypted signal may be sent to the encryption/decryption module 4′, and via the data interface 9′ the decryption key may be retrieved from the memory element 8′. The encryption/decryption module 4′ may use the decryption key to decrypt the encrypted signal. Via data interface 11′ the decrypted signal may be sent to the I/O control module 6′. Via the data interface 12′ the decrypted signals may be sent to the electro-acoustic converter, and the recipient of the phone call is then able to hear the words sent by the user of the transmitting communication device 27.

Any further exchange of information may take place substantially in accordance with this general scheme, with transmitted signals being encrypted and received signals being decrypted.

Thus, it will be appreciated that embodiments of the system and method provide a technical solution which can be used in all areas of communication involving communication devices, especially phones, to better protect the confidentiality of data and information.

Although the invention has been described with reference to the one or more embodiments illustrated in the figures, it is understood that equivalents may be employed and substitutions made herein without departing from the scope of the invention as recited in the claims.

Having thus described one or more embodiments of the invention, what is claimed as new and desired to be protected by Letters Patent includes the following:

1. A system for encrypting and decrypting data for communication via a communication device, the system comprising:
a chip including—
a memory element storing an encryption key and a decryption key;
an encryption/decryption module encrypting transmit data using the encryption key stored in the memory element and decrypting receive data using the decryption key stored in the memory element;
an input/output control module controlling input operations to the chip from one or more input devices and output operations from the chip to one or more output devices; and
at least one chip controller managing operations of and communication between the memory element, the encryption/decryption module, and the input/output control module,
wherein the memory element, the encryption/decryption module, the input/output control module, and the at least one chip controller are physically connected by and communicate with each other using a plurality of physical signal conductors.

2. The system as set forth in claim 1, wherein the encryption/decryption module sends the transmit data to a modem for transmission, and receives the receive data from the modem.

3. The system as set forth in claim 1, wherein the at least one chip controller provides a communication protocol for managing communication via the plurality of physical signal conductors.

4. The system as set forth in claim 1, wherein the at least one chip controller communicates with a network server via a data network to initially access the encryption key and the decryption key which are then stored in the memory element.

5. The system as set forth in claim 1, further including a security hardware element preventing unauthorized access to the encryption key and the decryption key stored in the memory element.

6. The system as set forth in claim 1, further including a radio-frequency spectrum analyzer detecting electronic eavesdropping, and communicating detection of electronic eavesdropping on a display of the communication device.

7. A system for encrypting and decrypting data for communication via a mobile communication device, the system comprising:
a chip incorporated into the mobile communication device and including—
a plurality of physical signal conductors facilitating communication of electronic signals;
a memory element storing an encryption key and a decryption key;
an encryption/decryption module in communication via the plurality of physical signal conductors with the memory element and a modem component of the mobile communication device, and encrypting transmit data for transmission via the modem component using the encryption key stored in the memory element and decrypting receive data received via the modem component using the decryption key stored in the memory element;
an input/output control module controlling input operations to the chip from one or more input devices and output operations from the chip to one or more output devices; and
at least one chip controller in communication via the plurality of physical signal conductors with and managing operations of the memory element, the encryption/decryption module, and the input/output control module, and providing a communication protocol for managing communication via the plurality of physical signal conductors.

8. The system as set forth in claim 7, wherein the at least one chip controller communicates with a network server via a data network to initially access the encryption key and the decryption key which are then stored in the memory element.

9. The system as set forth in claim 7, further including a security hardware element preventing unauthorized access to the encryption key and the decryption key stored in the memory element.

10. The system as set forth in claim 7, further including a radio-frequency spectrum analyzer detecting electronic eavesdropping, and communicating detection of electronic eavesdropping on a display of the mobile communication device.

11. A system for encrypting and decrypting data for communication via a mobile communication device, the system comprising:
a chip incorporated into the mobile communication device and including—
a plurality of physical signal conductors facilitating communication of electronic signals;
a memory element storing an encryption key and a decryption key, the memory element being associated with a security hardware element preventing unauthorized access to the encryption key and the decryption key stored in the memory element;
an encryption/decryption module in communication via the plurality of physical signal conductors with the memory element and a modem component of the mobile communication device, and encrypting transmit data for transmission via the modem component using the encryption key stored in the memory element and decrypting receive data received via the modem component using the decryption key stored in the memory element;
an input/output control module controlling input operations to the chip from one or more input devices and output operations from the chip to one or more output devices;
a radio-frequency spectrum analyzer detecting electronic eavesdropping, and communicating detection of electronic eavesdropping on a display of the mobile communication device; and
at least one chip controller—
in communication via the plurality of physical signal conductors with and managing operations of the memory element, the encryption/decryption module, the input/output control module, and the radio-frequency spectrum analyzer,
providing a communication protocol for managing communication via the plurality of physical signal conductors, and
in communication with a network server via a data network to initially access the encryption key and the decryption key which are then stored in the memory element.
